(19) United States
(12) Patent Application Publication
(10) Pub. No.: US 2014/0059562 A1
(43) Pub. Date: Feb. 27, 2014

(54) COMPUTER-READABLE RECORDING MEDIUM ON WHICH SCHEDULE MANAGEMENT PROGRAM IS RECORDED, SCHEDULE MANAGEMENT APPARATUS AND SCHEDULE MANAGEMENT METHOD

(71) Applicant: FUJITSU LIMITED, Kawasaki-shi (JP)

(72) Inventors: Yoshitaka KURUMA, Hino (JP); TOMOHISA SUZUKI, Kawasaki (JP); Ichirou GOTOU, Kawasaki (JP)

(21) Appl. No.: 13/928,420

(22) Filed: Jun. 27, 2013

(30) Foreign Application Priority Data
Aug. 21, 2012 (JP) 2012-182071

(51) Int. Cl. G06F 9/48

(52) U.S. Cl. CPC G06F 9/4843
USPC 718/106

(57) ABSTRACT

A processor registers a scheduled start timing and a scheduled end timing for each of a plurality of processes in advance into a storage unit, decides, based on the scheduled start timings and the scheduled end timings registered in the storage unit, whether or not the processes have a dependency relationship therebetween, and extracts a plurality of schedule paths by connecting those of the processes decided to have the dependency relationship therebetween to each other. A schedule path of the processes can be produced in a simplified maker without significantly breaking the accuracy of the time relationship among the processes.

### CROSS-REFERENCE TO RELATED APPLICATION

This application is based upon and claims the benefit of priority of the prior Japanese Application No. 2012-182071 filed on Aug. 21, 2012 in Japan, the entire contents of which are hereby incorporated by reference.

### FIELD

The embodiments discussed herein are directed to a computer-readable recording medium on which a schedule management program is recorded, a schedule management apparatus and a schedule management method.

### BACKGROUND

Design work in product development and so forth is implemented and carried out in accordance with a flow of fragmented design processes. Each of fragmented design processes (hereinafter referred to simply as process) has a dependency relationship to a different process, and the design processes are sequenced and carried out orderly in accordance with the dependency relationship so that the design work is progressed.

Processes have various dependency relationships (elements) therebetween. For example, such elements as listed below are available as the elements:

(1) Input-output relationship between deliverables obtained by processes

(2) Dependency relationship between processes

(3) Schedule (number of steps)

(4) Allocation situation of persons in charge

(5) Priority order/risk of work

An operator or the like would input and register such a great number of elements as described just above into a data storage unit such as a database for each process, and extract and produce a critical path by manual operation or using a project management supporting tool for managing steps of a design schedule or a like tool based on the registered elements. The critical path is a path (flow configured from a plurality of processes) that is significant in management and has a high degree of possibility that it may have an influence on the schedule of the design work. The extracted critical path is displayed as a Gantt chart together with an execution schedule of processes on a display unit (critical path displaying unit).

A manager or the like of a project would refer to the critical path (significant path in the project) displayed in such a manner as described above on the screen of the display unit and practically uses the critical path for management of the schedule of the design work.

Incidentally, work of inputting and registering dependency relationship information (for example, the elements (1) to (5) described above) for each process to be carried out by an operator or the like must be executed for 100 to 200 processes per one project, and one day or, where long time is required, one week or more is sometimes required for the work.

Especially, in order to carryout step management (schedule management) of work including multistage processes, it is necessary for an operator or the like to confirm a dependency relationship (such a relationship that, if a process is not completed, then a different process is not started) between processes in advance and then produce a path (schedule path) of processes. An enormous number of steps or time is required for the confirmation of the dependency relationship.

Since an input-output relationship between deliverables and a dependency relationship between processes are complicated, an input miss is likely to occur upon work for inputting registration.

Further, the input registration work is required for every schedule change and makes an obstacle to smooth project operation.

### SUMMARY

In one scheme, a computer-readable recording medium stores a schedule management program that makes a computer manage a schedule of a work including a plurality of processes, the program instructing the computer to execute deciding, based on a scheduled start timing and a scheduled end timing registered in advance for each of the processes, whether or not the processes have a dependency relationship therebetween, and extracting a plurality of schedule paths by connecting those of the processes decided to have the dependency relationship therebetween to each other.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a block diagram depicting a hardware configuration and a functional configuration of a schedule management apparatus of a first embodiment;

FIG. 2 is a view depicting an example of a start and completion date setting screen image;

FIG. 3 is a view depicting an example of a process management list registered and stored in a storage unit depicted in FIG. 1;

FIG. 4 is a view illustrating a summary;

FIG. 5 is a view depicting an example of a schedule path and a simplified critical path extracted and displayed by the schedule management apparatus depicted in FIG. 1;

FIG. 6 is a flow chart illustrating operation of the schedule management apparatus depicted in FIG. 1;

FIG. 7 is a flow chart illustrating extraction operation of a schedule path (inter-summary path) by the schedule management apparatus depicted in FIG. 1;

FIG. 8 is a flow chart illustrating extraction operation of a simplified critical path (simplified critical inter-summary path) by the schedule management apparatus depicted in FIG. 1;

FIGS. 9 to 13 are views particularly illustrating operation of the schedule management apparatus depicted in FIG. 1;

FIG. 14 is a block diagram depicting a hardware configuration and a functional configuration of a schedule management apparatus according to a second embodiment;

FIG. 15 is a view depicting an example of a process management list used by the schedule management apparatus depicted in FIG. 14;

FIG. 16 is a flow chart illustrating operation of the schedule management apparatus depicted in FIG. 14; and

FIGS. 17 to 19, 20A, 20B, 21A, 21B and 22 are views particularly illustrating operation of the schedule management apparatus depicted in FIG. 14.

### DESCRIPTION OF THE PREFERRED EMBODIMENTS

In the following, embodiments are described with reference to the drawings.

### [1] First Embodiment

[1-1] Configuration and Function of the Schedule Management Apparatus of the First Embodiment

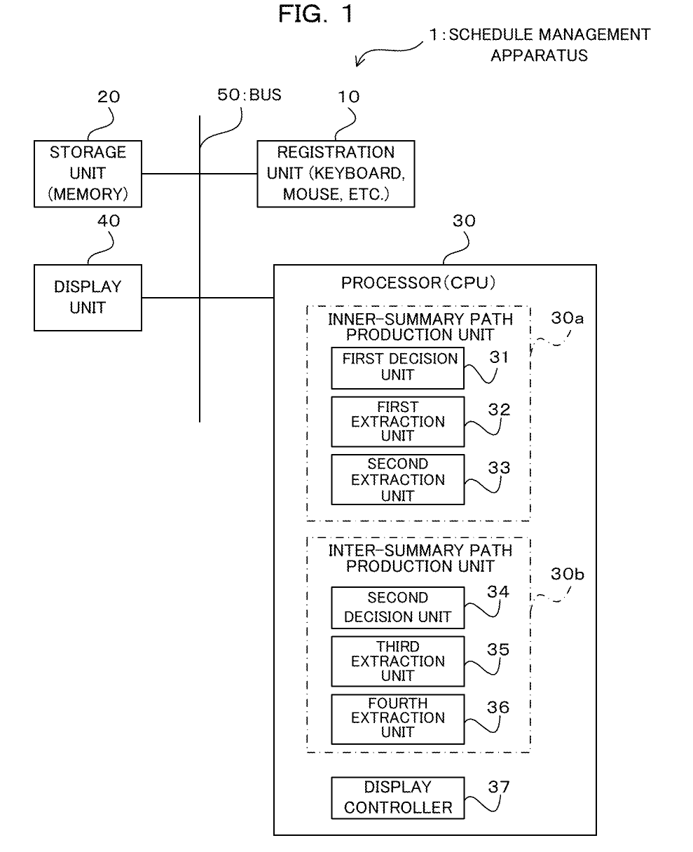

FIG. 1 is a block diagram depicting a hardware configuration and a functional configuration of a schedule management apparatus 1 according to a first embodiment.

The schedule management apparatus 1 depicted in FIG. 1 manages a schedule of work that includes a plurality of processes and is a project management supporting tool that manages steps of, for example, a design schedule. Further, the schedule management apparatus 1 is configured from a general personal computer or the like and includes a registration unit 10, a storage unit 20, a processor 30 and a display unit 40 that are connected for communication to each other through a bus 50.

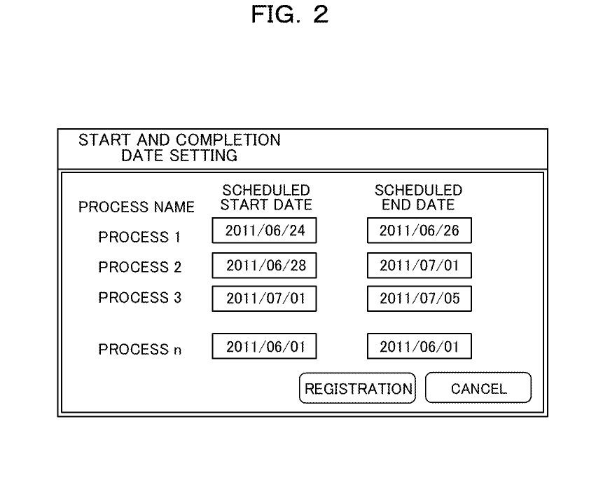

The registration unit 10 is a man-machine interface that includes a keyboard, a mouse and so forth to be operated by an operator or the like and is used to input and register a scheduled start date (scheduled start timing) and a scheduled end date (scheduled end timing) of each process. Thereupon, the operator or the like would refer to such a start and completion date setting screen image (popup window) as shown in FIG. 2, which is displayed on the display unit 40, and enters a scheduled start date/scheduled end date using the keyboard, the mouse or the like in a column of the scheduled start date/scheduled end date for each process on the screen image. The operator or the like would input the scheduled start date/scheduled end date regarding all of processes (in the example depicted in FIG. 2, a process 1 to a process n (n is a natural number equal to or greater than 4)) and then click a registration button on the start and completion date setting screen image. In response to the click, the scheduled start dates/scheduled end dates registered in the columns of the individual processes are registered into a process management list to be stored into the storage unit 20. It is to be noted that FIG. 2 is a view depicting an example of the start and completion date setting screen image (popup window).

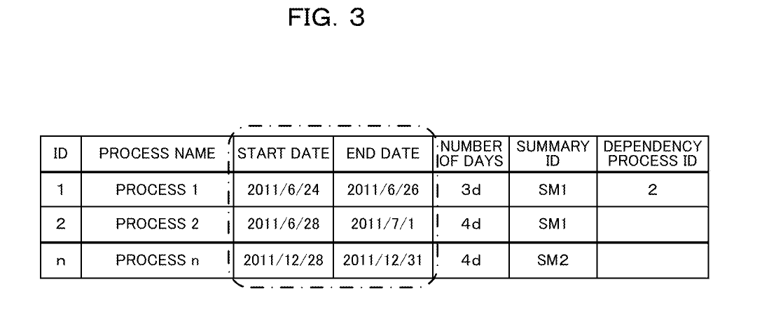

For example, as depicted in FIG. 3, an ID, a step name, a start date, an end date, a number of days, a summary ID and a dependency step ID are registered as elements in the process management list. FIG. 3 is a view depicting an example of the process management list to be registered and stored into the storage unit 20 depicted in FIG. 1.

The ID is an identification number (automatic serial number; 1, 2, . . . , n) allocated to each process. The step name is a name of each process (task name; process 1 to process n). The start date is a scheduled start date (year, month and day) and the end date is a scheduled end date (year, month and day) of each process. The number of days is a period automatically calculated based on the start date and the end date. It is to be noted that, while, in the present embodiment, the scheduled start timing/scheduled end timing are registered as the scheduled start date/scheduled end date (year, month and day) and the period of each process is registered as the number of days, otherwise the scheduled start timing/scheduled end timing may be registered as a scheduled start date/scheduled end date and the period of each process may be registered in a unit of an hour or a unit of a minute.

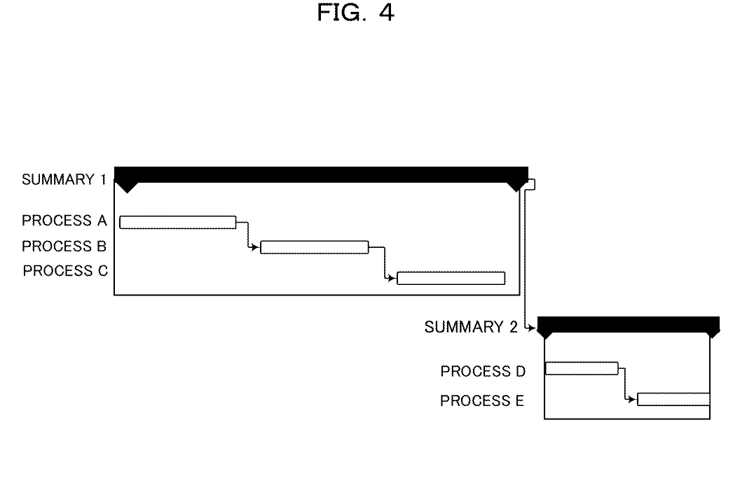

The summary ID is an identification number for specifying, where a summary exists in an higher order of and manages some processes, the summary to which the processes belong. Here, the summary is a group when the processes are grouped in a project as depicted in FIG. 4. FIG. 4 is a view illustrating a summary and depicts an example in which three processes A to C belong to a summary 1 and two processes D and E belong to a summary 2. Meanwhile, FIG. 3 depicts an example in which processes 1 and 2 belong to a summary whose summary ID is SM1 and a process n belongs to another summary whose summary ID is SM2. Where a summary exists in an higher order of and manages some processes, the processes are grouped into the summary by setting a summary ID thereto. However, where no summary exists in an higher order of and manages some processes, no summary ID is set.

The dependency step ID is an identification number for specifying a dependency destination process where a dependency relationship between processes is determined in advance. In FIG. 3, an example in which the process 1 depends on the process 2 is depicted. Where the dependency relationship between processes is not determined in advance, no dependency step ID is set.

It is to be noted that, though not depicted in FIG. 3, also a person in charge of each process is registered as an element in the process management list.

In the present embodiment, only the start date (scheduled start date) and the end date (scheduled end date) from among the elements registered in the process management list described above are inputted from the registration unit 10 by the operator or the like. The number of days is automatically calculated based on the start date (scheduled start date) and the end date (scheduled end date) as described above. Further, the ID, step name, summary ID, dependency step ID and name of a person in charge are defined in advance upon production of the step.

The storage unit 20 may be configured from an internal storage device such as a RAM (RandomAccess Memory), an HDD (Hard Disk Drive) or an SSD (Solid State Drive) or from an external storage apparatus. The storage unit 20 stores at least the process management list described above with reference to FIG. 3 and a schedule management program of causing a computer (processor 30) to operate the schedule management program therein.

The processor (CPU (Central Processing Unit), computer or processor) 30 reads out and executes the schedule management program stored in the storage unit 20 so as to function as a first decision unit 31, a first extraction unit 32, a second extraction unit 33, a second decision unit 34, a third extraction unit 35, a fourth extraction unit 36 and a display controller 37.

The first decision unit 31, first extraction unit 32 and second extraction unit 33 configure an inner-summary path production unit 30a that produces and extracts a schedule path (hereinafter described) or a simplified critical path (hereinafter described) in regard to processes in a summary where the processes are grouped in a summary or processes where the processes are not grouped in a summary.

The second decision unit 34, third extraction unit 35 and fourth extraction unit 36 configure an inter-summary path production unit 30b that produces and extracts an inter-summary path (hereinafter described) or a simplified critical path (hereinafter described) about a summary where processes are grouped in a summary. It is to be noted that, as hereinafter described, the second decision unit 34, third extraction unit 35 and fourth extraction unit 36 carry out a process similar to that carried out for the processes by the first decision unit 31, first extraction unit 32 and second extraction unit for each summary. In particular, the summary, inter-summary path and simplified critical path in the inter-summary path production unit 30b correspond to the process, schedule path and simplified critical path in the inner-summary path production unit 30a, respectively.

The first decision unit 31 decides whether or not a plurality of processes have a dependency relationship therebetween based on the scheduled start dates and the scheduled end dates registered in the storage unit 20 (process management list). In particular, the first decision unit 31 decides that a first process that is a decision target and a second process whose scheduled start date is later than the scheduled end date of the first process from among the processes have a dependency relationship therebetween.

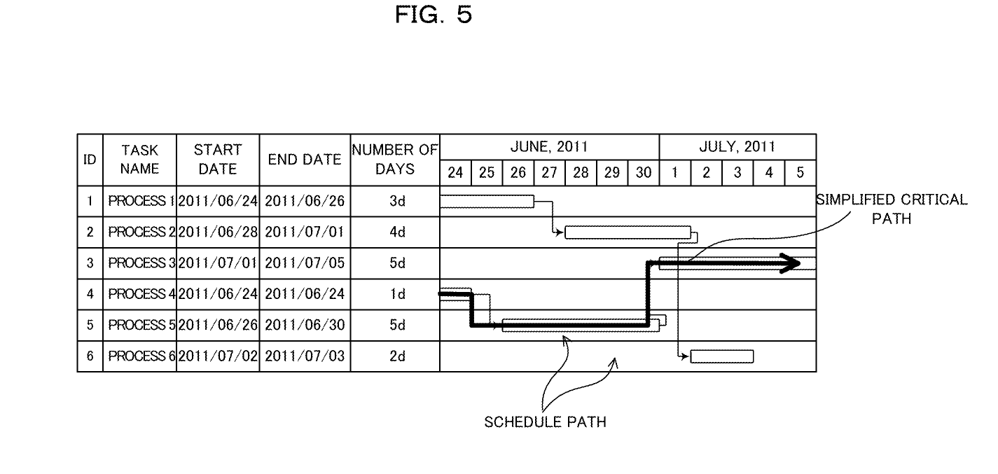

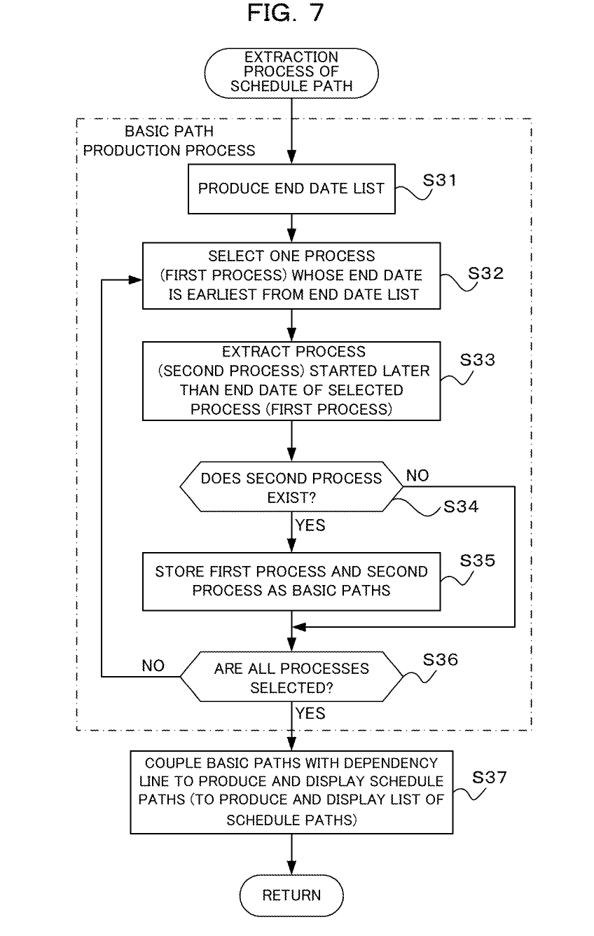

The first extraction unit 32 chains processes determined to have a dependency relationship therebetween by the first decision unit 31 in a row to extract a plurality of schedule paths. On the display unit 40, a first process and a second process that have a dependency relationship therebetween are connected by a dependency line (refer to a thin line arrow mark) as depicted in FIG. 5, and the processes connected to each other by a dependency line are extracted and displayed as a schedule path. It is to be noted that the extraction operation of a schedule path by the first decision unit 31 and the first extraction unit 32 is hereinafter described in detail with reference to FIGS. 7 and 9 to 12.

The second extraction unit 33 extracts, from among the schedule paths extracted by the first extraction unit 32, a schedule path complicated in process configuration as a simplified critical path. Particularly, the second extraction unit 33 extracts a schedule path that includes the greatest number of stages of processes connected to each other as a simplified critical path. Further, if a plurality of schedule paths having the greatest number of stages of connected processes are extracted, then the second extraction unit 33 extracts, from among the schedule paths having the same stage number, a schedule path longest in period (number of days) as a simplified critical path. In other words, the second extraction unit 33 decides a path having the greatest number of stages of processes (path complicated in configuration) as a significant path and decides, if a plurality of paths having the same greatest number of stages of connected processes are extracted, a schedule path long in period as a significant path.

It is to be noted that, if a plurality of schedule paths having the same number of stages of processes and the same period (number of days) are detected, then the second extraction unit 33 extracts all of the extracted schedule paths as simplified critical paths.

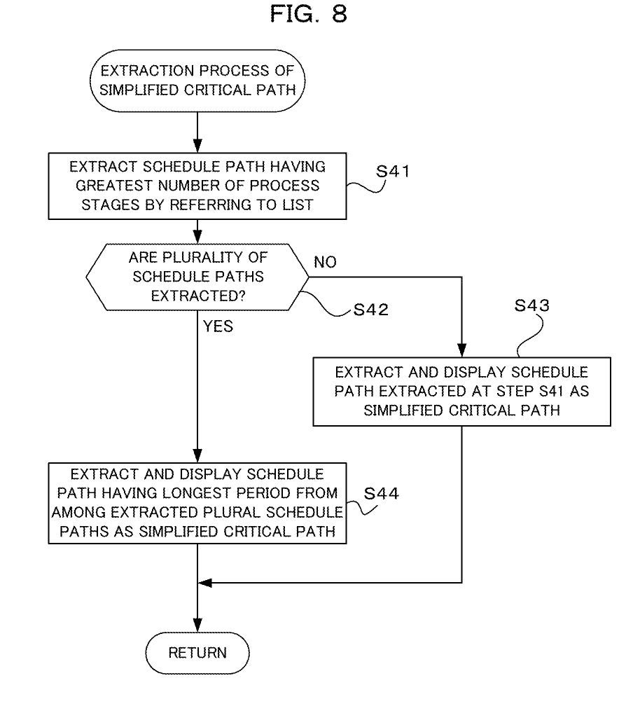

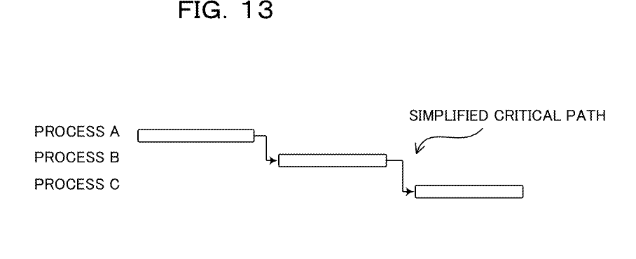

On the other hand, if a plurality of processes are grouped in a plurality of summaries as depicted in FIG. 4, then the second extraction unit 33 cooperates with the first decision unit 31 and the first extraction unit 32 to extract schedule paths and a simplified critical path in a similar manner as described above from two or more processes included in each summary. It is to be noted that the extraction operation of a simplified critical path by the second extraction unit 33 is hereinafter described with reference to FIGS. 8 and 13.

The second decision unit 34 decides, based on a scheduled start date (earliest one of scheduled start dates of two or more processes) and a scheduled end date (latest one of scheduled end dates of two or more processes) registered in advance in the storage unit 20 for each of two or more processes included in each of a plurality of summaries, whether or not the summaries have a dependency relationship therebetween. Particularly, the second decision unit 34 decides that a first summary of a decision target from among a plurality of summaries and a second summary whose earliest scheduled start date is later than the latest scheduled end date of the first summary have a dependency relationship therebetween.

The third extraction unit 35 extracts a plurality of inter-summary paths (corresponding to schedule paths between the processes) by connecting those summaries decided to have a dependency relationship therebetween by the second decision unit 34. On the display unit 40, a first summary and a second summary that have a dependency relationship therebetween are connected to each other by a dependency line (refer to a thin line arrow mark) as depicted in FIG. 4, and summaries connected to each other by a dependency line are extracted and displayed as an inter-summary path. It is to be noted that the extraction operation of an inter-summary path by the second decision unit 34 and the third extraction unit 35 is hereinafter described in detail with reference to FIGS. 7 and 9 to 12.

The fourth extraction unit 36 extracts, from among a plurality of inter-summary paths detected by the third extraction unit 35, an inter-summary path complicated in summary configuration as a simplified critical inter-summary path. Particularly, the fourth extraction unit 36 extracts, from among the inter-summary paths, an inter-summary path greatest in number of stages of connected summaries as a simplified critical inter-summary path. Further, if a plurality of inter-summary paths having the greatest number of stages of connected summaries are extracted, then the fourth extraction unit 36 extracts, from among the inter-summary paths of the same stage numbers, an inter-summary path longest in period (number of days) as a simplified critical inter-summary path. It is to be noted that the extraction operation of a simplified critical inter-summary path by the fourth extraction unit 36 is hereinafter described with reference to FIGS. 8 and 13.

The display controller 37 controls the display state of the display unit 40. In particular, the display controller 37 controls the display unit 40 to display such a start-completion date setting screen image as depicted in FIG. 2 or display a schedule path extracted by the first extraction unit 32, a simplified critical path extracted by the second extraction unit 33, an inter-summary path extracted by the third extraction unit 35 and a simplified critical inter-summary path extracted by the fourth extraction unit 36 as depicted in FIG. 5.

It is to be noted that FIG. 5 is a view depicting an example of a schedule path and a simplified critical path extracted and displayed by the schedule management apparatus 1 depicted in FIG. 1. In the display example depicted in FIG. 5, on the left side of the screen image, information of a process management list registered in the storage unit 20 is displayed, and on the right side of the screen image, a schedule path extracted by the first extraction unit 32 and a simplified critical path extracted by the second extraction unit 33 are displayed in the form of a Gantt chart. In the Gantt chart of FIG. 5, two schedule paths, namely, a path including processes 1, 2 and 6 connected to each other by a dependency line (refer to a thin line arrow mark) and another path including processes 4, 5 and 3 connected to each other by a dependency line (refer to a thin line arrow mark) are depicted. Further, from among the two schedule paths, a schedule path that includes the processes 4, 5 and 3 connected by a dependency line is displayed as a simplified critical path (refer to a thick line arrow mark).

[1-2] Operation of the Schedule Management Apparatus of the First Embodiment

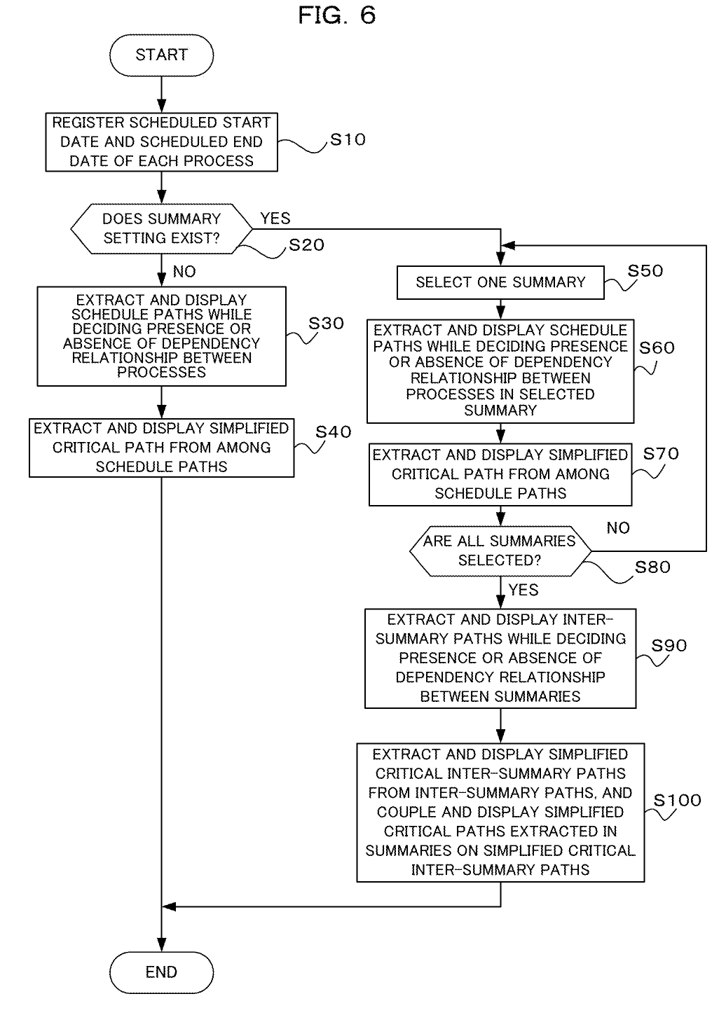

Now, operation of the schedule management apparatus 1 of the first embodiment configured in such a manner as described above is described with reference to FIGS. 6 to 13.

First, operation of the schedule management apparatus 1 depicted in FIG. 1 is described with reference to a flow chart (steps S10 to S100) depicted in FIG. 6.

In order to start a schedule, an operator or the like would refer to a start and completion date setting screen image (FIG. 2) displayed on the display unit 40 and operate a keyboard, a mouse and so forth included in the registration unit 10 to input a scheduled start date and a scheduled end date of each process. Consequently, the scheduled start dates and the scheduled end dates of the processes are placed and registered into a process management list stored in the storage unit 20, for example, as illustrated in FIG. 3 (step S10).

Then, the processor 30 decides whether or not summary setting has been carried out, in other words, whether or not a summary ID is set in the process management list (step S20).

If no summary is set (No route at step S20), then the following processes (steps S30 and S40) are executed.

In particular, while the first decision unit 31 decides based on the scheduled start dates and the scheduled end dates registered in the storage unit 20 whether or not a plurality of processes have a dependency relationship therebetween, the first extraction unit 32 chains those processes decided to have a dependency relationship therebetween by the first decision unit 31 into a row to extract a plurality of schedule paths. The extracted schedule paths are displayed on the display unit 40 by the display controller 37 (step S30). Details of the process at step S30 are hereinafter described with reference to FIGS. 7 and 9 to 12.

Thereafter, the second extraction unit 33 extracts a simplified critical path from among the schedule paths extracted by the first extraction unit 32, and the extracted simplified critical path is displayed on the display unit 40 by the display controller 37 (step S40). Then, the processor 30 ends the processing.

On the other hand, if a summary is set (Yes route at step S20), then the following processes (steps S50 to S100) are executed.

In particular, the processor 30 selects one summary from among the summaries (step S50). The first decision unit 31 decides based on the scheduled start dates and the scheduled end dates registered in the storage unit 20 whether or not the two or more processes included in the selected summary have a dependency relationship therebetween. Then, the first extraction unit 32 chains the processes decided to have a dependency relationship therebetween by the first decision unit 31 in a row to extract a plurality of scheduled paths. The extracted schedule paths are displayed on the display unit 40 by the display controller 37 (step S60). Details of the process at step S60 are hereinafter described with reference to FIGS. 7 and 9 to 12.

Thereafter, the second extraction unit 33 extracts a simplified critical path from among the schedule paths extracted by the first extraction unit 32, and the extracted simplified critical path is displayed on the display unit 40 by the display controller 37 (step S70).

Then, the processor 30 decides whether or not all summaries are selected, namely, whether or not the processes at steps S50 to S70 are executed for all summaries (step S80). If all summaries are not selected (NO route at step S80), then the processor 30 returns the processing to step S50. On the other hand, if all summaries are selected (YES route at step S80), then the processor 30 advances the processing to step S90.

At step S90, the second decision unit 34 decides based on the earliest scheduled start date and the latest scheduled end date in each summary whether or not the summaries have a dependency relationship therebetween. Further, the third extraction unit 35 connects the summaries decided to have a dependency relationship therebetween by the second decision unit 34 in a row to extract a plurality of inter-summary paths. The extracted inter-summary paths are displayed on the display unit 40 by the display controller 37. Details of the process at step S90 are hereinafter described with reference to FIGS. 7 and 9 to 12.

Thereafter, the fourth extraction unit 36 extracts a simplified critical inter-summary path from among the inter-summary paths extracted by the third extraction unit 35, and the extracted simplified critical inter-summary path is displayed on the display unit 40 by the display controller 37. Further, the processor 30 couples the simplified critical paths extracted from the summaries on the simplified critical inter-summary paths to produce a general simplified critical path. The general simplified critical path produced in this manner is displayed on the display unit 40 by the display controller 37 (step S100). Then, the processor 30 ends the processing.

Now, an extraction operation of a schedule path by the schedule management apparatus 1 depicted in FIG. 1 (the detection process of a schedule path at step S30 of FIG. 6) is described with reference to a flow chart (steps S31 to S37) depicted in FIG. 7. It is to be noted that a basic path production process is executed by the processes at steps S31 to S36.

First, the processor 30 (first decision unit 31) extracts the end date (scheduled end date) of all processes that make a target from within the process management list of the storage unit 20 to produce an end date list (step S31). The first decision unit 31 selects a process (first process) having the earliest end date from within the end date list (step S32). Then, the first decision unit 31 refers to the process management list of the storage unit 20 to extract a process (second process) that is to be started later than the end date of the selected process (step S33).

At this time, if a second process is extracted (YES route at step S34), then the first decision unit 31 decides that the first process and the second process have a dependency relationship therebetween and stores the first process and the second process in pair as a basic path into the storage unit 20 (step S35). However, if no second process is extracted (NO route at step S34), then the processor 30 advances the processing to step S36 skipping step S35.

At step S36, the processor 30 decides whether or not the end dates of all processes in the end date list have been selected, namely, whether or not the processes at steps S32 to S35 have been executed for the end dates of all processes. If the end dates of all processes have not been selected (NO route at step S36), then the processor 30 returns the processing to step S32. On the other hand, if the end dates of all processes have been selected (YES route at step S36), then the first extraction unit 32 couples the basic paths stored in the storage unit 20 to each other through a dependency line to produce schedule paths and produces a list of such schedule paths. The produced scheduled paths are displayed on the display unit 40 by the display controller 37 (step S37).

It is to be noted that also the extraction process of a schedule path for each summary at step S60 of FIG. 6 is executed by a procedure similar to that at steps S31 to S37 described above.

Further, the extraction process of an inter-summary path at step S90 of FIG. 6 is executed by a procedure substantially similar to that at steps S31 to S37 described above. It is to be noted, however, that the process and the schedule path at steps S31 to S37 described above are replaced by a summary and an inter-summary path, respectively, and the first decision unit 31 and the first extraction unit 32 are replaced by the second decision unit 34 and the third extraction unit 35, respectively.

Now, a detection operation of a simplified critical path by the schedule management apparatus 1 (the detection process of a simplified critical path at step S40 of FIG. 6) is described with reference to a flow chart (steps S41 to S44) depicted in FIG. 8.

The second extraction unit 33 refers to the list of schedule paths produced at step S37 of FIG. 7 to extract a schedule path that has the greatest number of stages of processes (step S41). Then, the second extraction unit 33 specifies whether or not a plurality of schedule paths having the greatest number of stages of processes exist (step S42). If the number of schedule paths having the greatest number of stages of processes is one (NO route at step S42), then the second extraction unit 33 extracts the schedule path extracted at step S41 as a simplified critical path. The extracted simplified critical path is displayed on the display unit 40 by the display controller 37 (step S43).

On the other hand, if a plurality of schedule paths having the greatest number of stages of processes exist (YES route at step S42), then the second extraction unit 33 extracts, from among the extracted schedule paths having the same greatest number of stages, a schedule path longest in period (number of days) as a simplified critical path. The extracted simplified critical path is displayed on the display unit 40 by the display controller 37 (step S44). It is to be noted that, if a plurality of schedule paths having the same number of stages of processes and the same period (number of days) are extracted, then the second extraction unit 33 extracts all of the extracted schedule paths as simplified critical paths.

It is to be noted that also the extraction process of a simplified critical path in the summaries at step S70 of FIG. 6 is executed by a procedure similar to that at steps S41 to S44 described hereinabove.

Further, it is to be noted, however, that the process, schedule path and simplified critical path at steps S41 to S44 are replaced by a summary, an inter-summary path and a simplified critical inter-summary path, respectively, and the second extraction unit 33 is replaced by the fourth extraction unit 36.

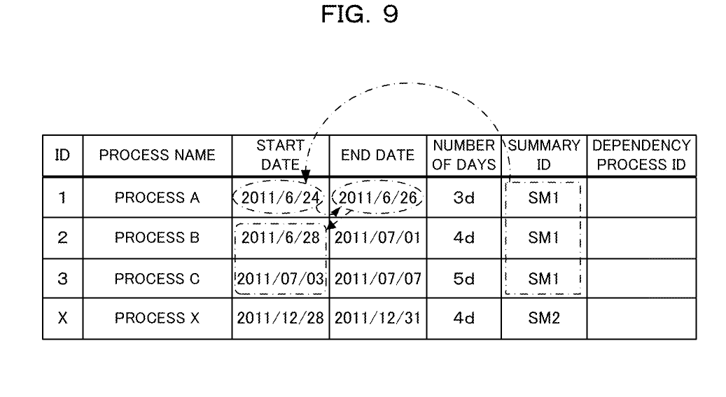

Here, operation of the schedule management apparatus 1 depicted in FIG. 1 is described particularly with reference to FIGS. 9 to 13. In particular, a particular procedure of extracting a schedule path and a simplified critical path from three processes A to C included in a summary whose summary ID is SM1 based on such a process management list as depicted in FIG. 9 is described. The procedure described here is a procedure for extracting a schedule path and a simplified critical path regarding the processes in the summary and corresponds to the processes at steps S60 and S70 of FIG. 6.

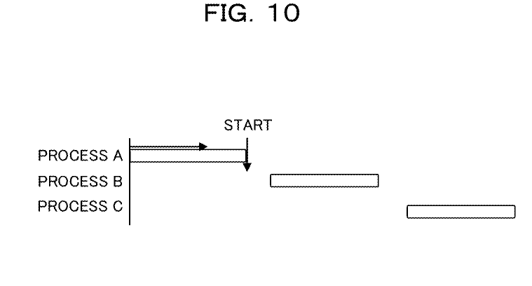

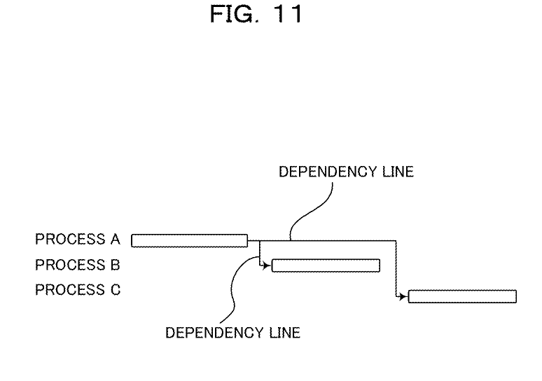

An end date list of the processes in the summary SM1 obtained from the process management list depicted in FIG. 9 includes 2011/6/26 of the process A, 2011/7/1 of the process B and 2011/7/7 of the process C. The first decision unit 31 selects the process A having the earliest end date (step S32 of FIG. 7; refer to “start” in FIG. 10), refers to the process management list depicted in FIG. 9 and extracts the two processes B and C started later than the end date of the process A (step S33 of FIG. 7; refer to FIGS. 9 and 11). Accordingly, the first decision unit 31 decides that the process A and the process B have a dependency relationship therebetween and decides that also the process A and the process C have a dependency relationship therebetween. The first decision unit 31 thus stores the two sets of the processes A˜B and the processes A˜C as basic paths into the storage unit 20 (step S35 of FIG. 7).

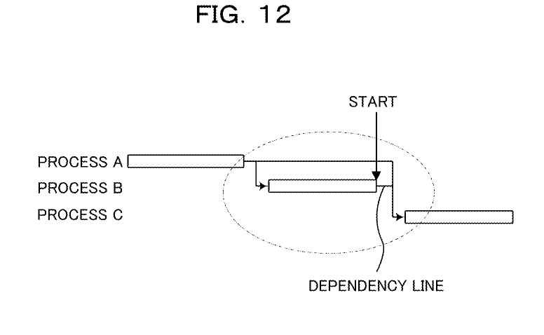

Thereafter, the first decision unit 31 selects the process B having the second earliest end date (step S32 of FIG. 7; refer to “start” in FIG. 12), and refers to the process management list depicted in FIG. 9 to extract the process C that is to be started later than the end date of the process B (step S33 of FIG. 7; refer to FIG. 12). Accordingly, the first decision unit 31 decides that the process B and the process C have a dependency relationship therebetween and stores the processes B˜C as a basic path into the storage unit 20 (step S35 of FIG. 7). Consequently, all basic paths (three basic paths) are extracted regarding the processes in the summary SM1.

Then, the first extraction unit 32 couples the basic paths stored in the storage unit 20 through a dependency line to produce a schedule path. In the example depicted in FIG. 12, a first schedule path (process A˜process B˜process C) wherein the two sets of basic paths, namely, the processes A˜B and the processes B˜C, are coupled through a dependency line, is produced. Further, in the example depicted in FIG. 12, the processes A˜C that form a basic path is produced as a second schedule path (process A˜process C). Accordingly, the connection stage number of processes in the first schedule path is 3, and the connection stage number of process in the second schedule path is 2.

Then, the second extraction unit 33 extracts, from between the two schedule paths depicted in FIG. 12, the first schedule path (process A˜process B˜process C) that has a greater number of connection stages of processes as a simplified critical path as depicted in FIG. 13.

Also regarding processes in the other summaries, a schedule path and a simplified critical path are extracted in a similar manner as described above.

Also regarding different summaries, an inter-summary path and a simplified critical inter-summary path are extracted in a similar manner as described above. Then, simplified critical paths extracted in regard to the summaries on the simplified critical inter-summary paths are coupled to produce a general simplified critical path, which is displayed on the display unit 40.

[1-3] Working Effect of the Schedule Management Apparatus of the First Embodiment

According to the schedule management apparatus 1 of the first embodiment, the operator can extract a schedule path and a simplified critical path only by registering a scheduled start timing and a scheduled end timing of processes without inputting all of conventional complicated elements. In particular, a dependency relationship between the processes is decided based on time relationships or periods of the scheduled start timings and the scheduled end timings of the processes, and those processes that have a dependency relationship therebetween are chained in a row to produce a series of scheduled processes (schedule path). Further, a plurality of schedule paths are compared with each other in multitude of the number of connection stages of processes (complicatedness in configuration) or in period (number of days) of the schedule paths. Thus, a significant path that is expected to have an influence on the project (schedule) is extracted simply as a simplified critical path and displayed on the display unit 40.

Consequently, a schedule path that is not a critical path in a strict sense but can make a key in design is extracted and displayed as a simplified critical path simply based on the scheduled start timings and the scheduled end timings of the processes. In short, since a dependency relationship between the processes is decided based on a small amount of information (contents of the processes need not be taken into consideration), a schedule path of the processes can be extracted simply. Further, since a simplified critical path is decided based on the information having a high degree of validity, also the decision accuracy is high.

Accordingly, it is possible to simply produce schedule paths of processes and extract and display a simplified critical path without significantly breaking the accuracy of the time relationship among the processes, and the simplified critical path can be utilized as a design management material. In other words, by utilizing information around the processes that are significant elements of display of schedule paths to simply produce schedule paths and a simplified critical path, an environment in which a work estimate or a review of the schedule can be carried out in a short period is established.

Further, since the user (operator or the like) must only register a scheduled start timing and a scheduled end timing of each process without inputting all of conventional complicated elements, the inputting burden on the user (operator or the like) is reduced significantly and the user can carry out inputting registration work in a short period of time to obtain a schedule path or a simplified critical path. Further, since complicated inputting registration work (inputting of input and output relationships between resulting objects, dependency relationships between processes and so forth) in which an input miss is likely to occur is not required any more, an input miss can be suppressed. Further, since inputting registration work can be carried out in a short period, even if inputting registration work is carried out every time a schedule is changed, the project can be operated smoothly.

Also in regard to the summary, an inter-summary path and a simplified critical inter-summary path can be extracted and displayed similarly to a schedule path and a simplified critical path, respectively. Consequently, working effects similar to those described hereinabove can be achieved. Further, by coupling simplified critical paths extracted regarding the summaries on the simplified critical inter-summary path, a general simplified critical path can be produced. Further, by dividing the processes in a unit of a summary and extracting and storing schedule paths and simplified critical paths regarding the processes in the summaries, only if a re-extraction process is carried out for a summary that includes a process that has undergone a change, then it is possible to easily cope with the change.

As described above, according to the schedule management apparatus 1 of the first embodiment, a schedule path and a simplified critical path are inferred and displayed only based on scheduled start timings and scheduled end timings without inputting all of the elements (refer to the items (1) to (5) described hereinabove) that have been necessary for a dependency relationship decision. Consequently, it becomes possible to extract and display a schedule path and a simplified critical path by inputting registration work for a short period of time and it becomes possible to represent a noticed path in a manner easy to understand and use the same as a material for decision when reconsideration of the schedule or the like is carried out. Such effects are effective in confirmation work at an initial stage of schedule construction or in a project for short delivery time.

In the following, working effects achieved by the schedule management apparatus 1 of the first embodiment, particularly, enhancement in efficiency of schedule registration work, are described in detail.

Production of a schedule upon launching of a project or production or change of a dependency relationship by a review of a schedule in accordance with the progress situation occurs regularly during a project period, once per month or every other week. Here, comparison of the time required for a single time of a review or production of a schedule between a case in which a strict critical path is extracted and another case in which a simplified critical path is extracted as in the present embodiment is described below.

In recording work for one process where a strict (detailed) critical path is extracted, the registration time required for one information piece (element) to be registered is such as indicated in Table 1.

TABLE 1

| INFORMATION PIECE TO BE | REGISTRATION TIME PER |
|---|---|
| REGISTERED | ONE CASE |
| SCHEDULED START DAY | 3 SECONDS |
| SCHEDULED END DAY | 3 SECONDS |
| PRIORITY RANK | 3 SECONDS |
| RISK TARGET FLAG | 3 SECONDS |
| DEPENDENCY RELATIONSHIP | 10 SECONDS × DEPENDENCY |
| BETWEEN PROCESSES | NUMBER |
| DEPENDENCY RELATIONSHIP | 10 SECONDS × DEPENDENCY |
| BETWEEN PERSONS IN CHARGE | NUMBER |
| (RESOURCES) | |
| DEPENDENCY RELATIONSHIP | 10 SECONDS × DEPENDENCY |
| BETWEEN DELIVERABLES | NUMBER |

Accordingly, where the dependency number is 2, the registration time required for one process is 72 seconds. If an average process number of a project is assumed to be 100, the registration time required for one project is 7,200 seconds. Actually, several hours are required for the investigation of the configuration of dependency relationships in addition to the registration time, and this investigation time is, for example, approximately 5 hours per one project.

On the other hand, where a simplified critical path is extracted as in the present embodiment, the registration time required for one information piece (element) to be registered in registration work for one process is such as indicated in Table 2.

TABLE 2

| INFORMATION PIECE TO BE | REGISTRATION TIME PER ONE |
|---|---|
| REGISTERED | CASE |
| SCHEDULED START DAY | 3 SECONDS |
| SCHEDULED END DAY | 3 SECONDS |

Accordingly, the registration time required for one process is 6 seconds. If an average process number of a project is assumed to be 100, then the registration time required for one project is 600 seconds. Actually, several hours are required for the investigation of the configuration of dependency relationships in addition to the registration time. However, in this instance, only investigation for the period (scheduled start time/scheduled end time) is involved, and therefore, the investigation time is, for example, approximately one hour per one protect.

Consequently, with the present embodiment, the time required for carrying out a review or production of a schedule once is reduced as given below per one project. In particular, the registration work time is shortened by one hour and 50 minutes and the investigation time is shortened by four hours, and consequently, the total time is shortened by five hours and 50 minutes. Therefore, the efficiency of the schedule registration work is enhanced significantly. It is to be noted that the investigation time for such factors as a general configuration of the project is omitted.

Shortened time of registration work time: 7,200 seconds−600 seconds=6,600 seconds (1 hour and 50 minutes)

Shortened time of investigation time: 5 hours−1 hour=4 hours

Totaling shortened time: 1 hour and 50 minutes+4 hours=5 hours and 50 minutes

### [2] Second Embodiment

[2-1] Configuration and Function of the Schedule Management Apparatus of the Second Embodiment

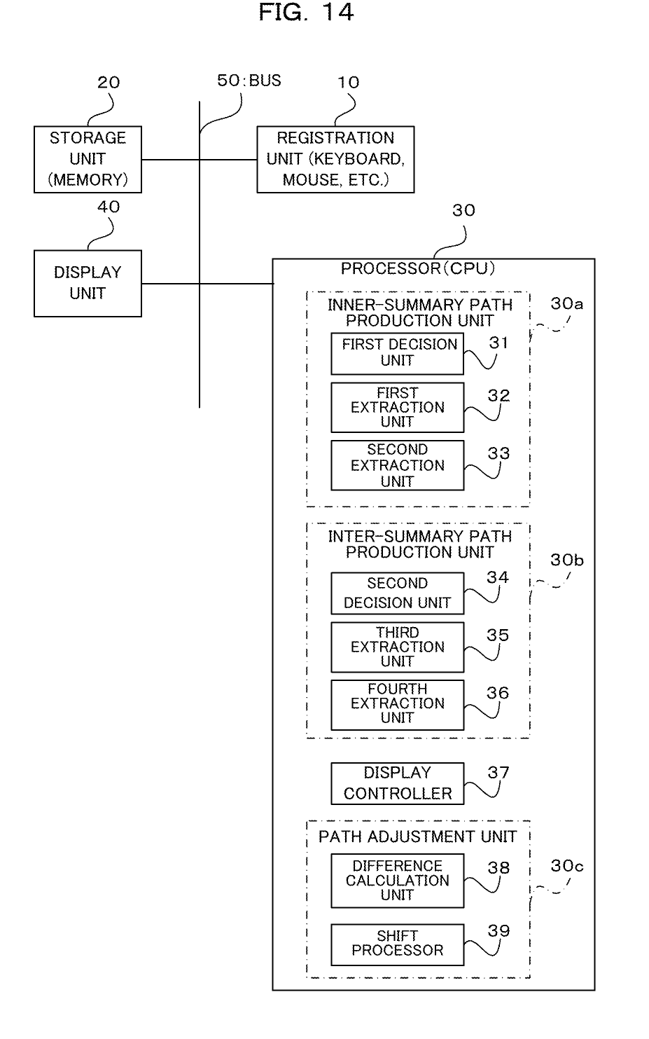

FIG. 14 is a block diagram depicting a hardware configuration and a functional configuration of a schedule management apparatus 1A of a second embodiment. It is to be noted that like reference characters to those described hereinabove denote like or substantially like portions, and therefore, detailed description of them is omitted herein.

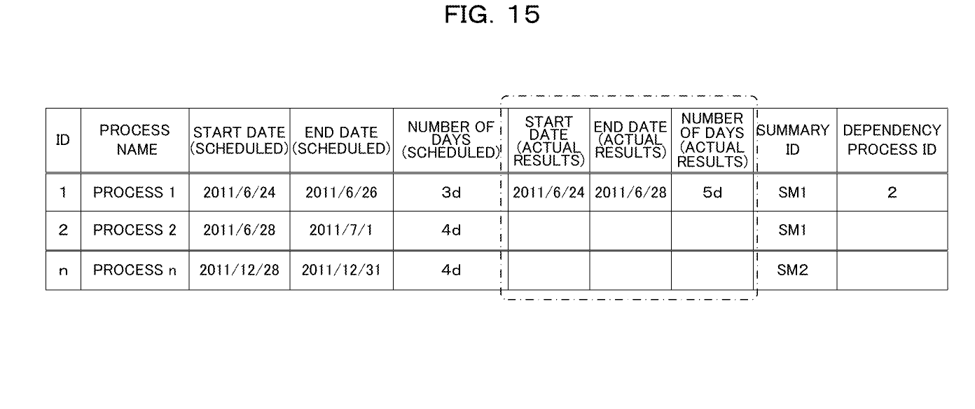

The schedule management apparatus 1A depicted in FIG. 14 includes a registration unit 10, a storage unit 20, a processor 30 and a display unit 40 connected for communication with each other through a bus 50 similarly to the schedule management apparatus 1 of the first embodiment. However, it is to be noted that, in the schedule management apparatus 1A, such a process management list as depicted in FIG. 15 is stored in the storage unit 20 and the processor 30 reads out and executes a schedule management program stored in the storage unit 20 to implement the functions as the first decision unit 31, first extraction unit 32, second extraction unit 33, second decision unit 34, third extraction unit 35, fourth extraction unit 36 and display controller 37 described hereinabove and further implement functions as a difference calculation unit 38 and a shift processor 39. It is to be noted that the difference calculation unit 38 and the shift processor 39 configure a path adjustment unit 30c.

Further, in the second embodiment, an operator or the like registers, from the registration unit 10, an actual start timing (start date (actual results)) or an actual end timing (end date (actual results)) for a process actually started or ended in accordance with the progress of the work into the process management list of the storage unit 20.

Furthermore, in the second embodiment, such a process management list as depicted in FIG. 15 is used. It is to be noted that FIG. 15 is a view illustrating an example of a process management list used in the schedule management apparatus 1A depicted in FIG. 14. The process management list depicted in FIG. 15 includes, in addition to the fields of the process management list in the first embodiment depicted in FIG. 3, fields for a start date (actual results), an end date (actual results) and a number of days (actual results). The additional fields remain blank until a start date (actual results)/end date (actual results) on which the process is actually started or ended is registered by the operator or the like. It is to be noted that the “start date (scheduled)” and the “end date (scheduled)” in FIG. 15 correspond to the “start date” and the “end date” in the first embodiment, respectively.

The start date (actual results) is a state date (year, month and day) that is registered by the operator or the like and on which the process is started actually. The end date (actual results) is an end date (year, month and day) that is registered by the operator or the like and on which the process is ended actually. The number of days (actual results) is a period that is automatically calculated based on the start date (actual results) and the end date (actual results) and is a period actually required for execution of the process. It is to be noted that, while, in the present embodiment, the actual start timing/actual end timing are registered in the form of a year, a month and a day and the period (actual results) of each process is registered in the form of a number of days, the actual start timing/actual end timing may otherwise be registered in the form of an actual start date and time and the period (actual results) of each process may otherwise be registered in a unit of an hour or in a unit of a minute.

If a start date (actual results) or an end date (actual results) of a process started or ended in accordance with the progress of work is registered into the process management list of the storage unit 20, then the difference calculation unit 38 executes the following processes. In particular, the difference calculation unit 38 calculates a difference between the start date (actual results) and the start date (scheduled) or a difference between the end date (actual results) and the end date (scheduled) corresponding to the end date (actual results) of the schedule path to which the started or ended process belongs.

The shift processor 39 shifts the timings of the start date (scheduled) and the end date (scheduled) of the schedule path, to which the started or ended process belongs, by an amount equal to the difference calculated by the difference calculation unit 38.

After the shifting by the shift processor 39 is carried out, the second extraction unit 33 cooperates with the first decision unit 31 and the first extraction unit 32 to extract a schedule path and a simplified critical path of the processes later than the started or ended process.

[2-2] Operation of the Schedule Management Apparatus of the Second Embodiment

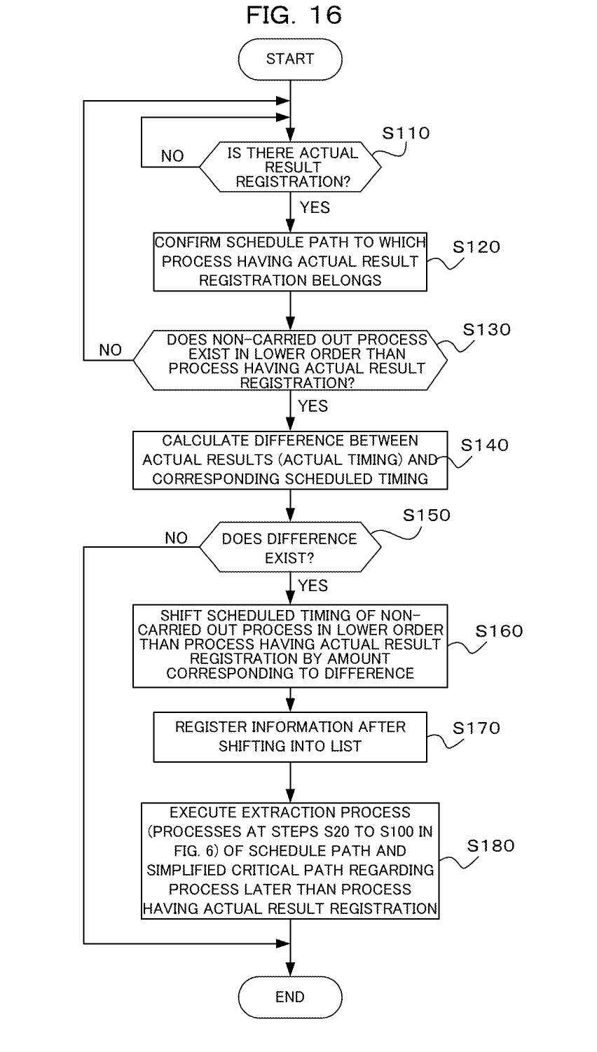

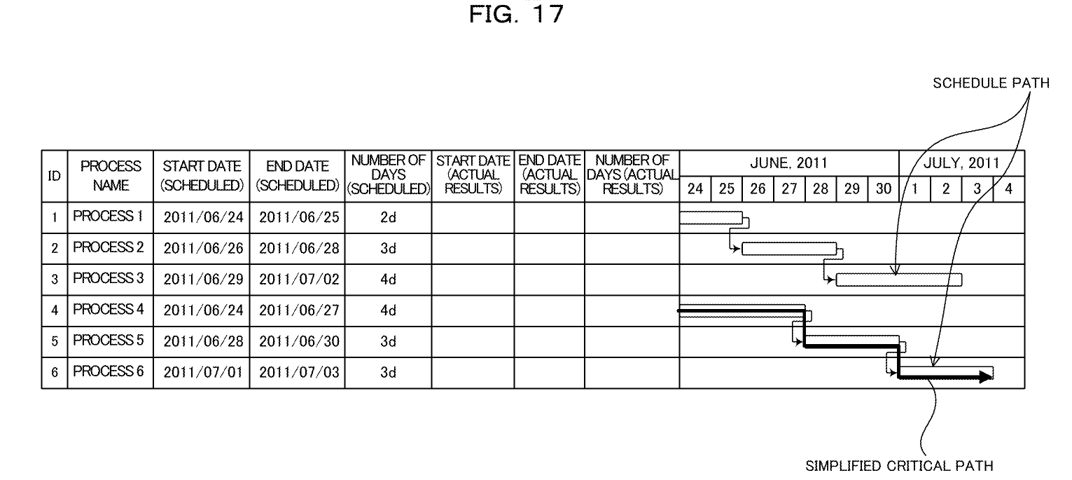

Now, operation of the schedule management apparatus 1A depicted in FIG. 14 is described with reference to FIGS. 17 to 22 in accordance with a flow chart (steps S110 to S180) illustrated in FIG. 16. It is to be noted that FIGS. 17 to 22 are views particularly illustrating operation of the schedule management apparatus 1A depicted in FIG. 14.

It is assumed here that such a process management list (refer to the left side in FIG. 17) and schedule paths and a simplified critical path (refer to the right side in FIG. 17) as illustrated in FIG. 17 are obtained first by the processes similar to those of the schedule management apparatus 1 of the first embodiment. In the Gantt chart of FIG. 17, two schedule paths, namely, a path including processes 1, 2 and 3 connected to each other by a dependency line and another path including processes 4, 5 and 6 connected to each other by another dependency line, are displayed. Further, from between the two schedule paths, the path including the processes 4, 5 and 6 connected to each other by a dependency line is displayed as a simplified critical path.

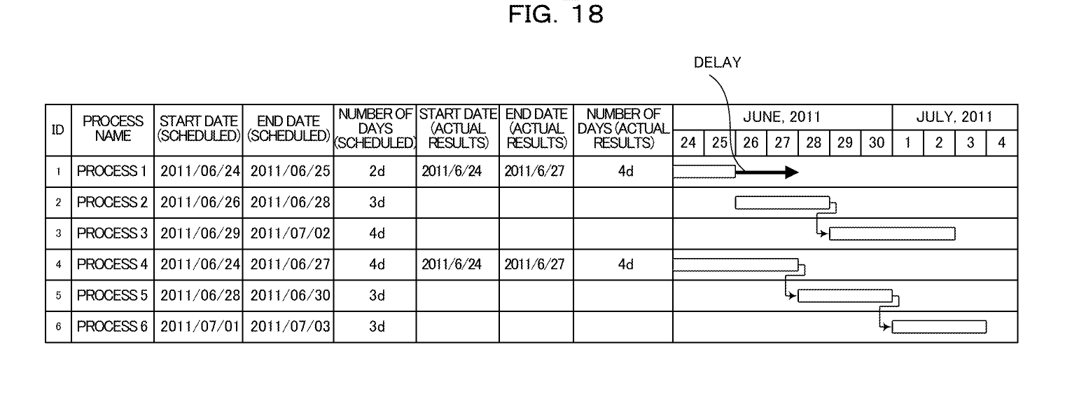

In the state described above, the processor 30 decides whether or not actual results (a start date (actual results) and/or an end date (actual result)) are registered by an operator or the like from the registration unit 10 (step S110). When actual results are registered (YES route at step S110), for example, as depicted in FIG. 18, if a start date (actual results) and an end date (actual results) of each of the processes 1 and 4 are registered, then the processor 30 confirms a schedule path to which the process (actually started or ended process) for which actual results are registered belongs (step S120). Then, the processor 30 decides whether or not a process for which no registration of actual results is carried out remains below the process for which actual results are registered in the schedule path (step S130).

If a process for which no actual processes are registered does not exist (NO route at step S130), then the processor 30 returns the processing to step S110.

On the other hand, if a process for which no actual processes are registered exists (YES route at step S130), then the difference calculation unit 38 calculates a difference between the start date (actual results) and the start date (scheduled) corresponding to the start date (actual results) or a difference between the end date (actual results) and the end date (scheduled) corresponding to the end date (actual results) regarding the schedule path to which the process for which actual results are registered belongs (step S140).

In the example depicted in FIG. 18, the difference calculation unit 38 calculates, regarding the process 1, a difference (delay of two days) between the end date (actual results) 2001/6/27 of the registration regarding the process 1 and the end date (scheduled) 2011/6/25 corresponding to the end date (actual results). Similarly, the difference calculation unit 38 calculates a difference (no difference) between the end date (actual results) 2001/6/27 of the registration regarding the process 4 and the end date (scheduled) 2011/6/27 corresponding to the end date (actual results).

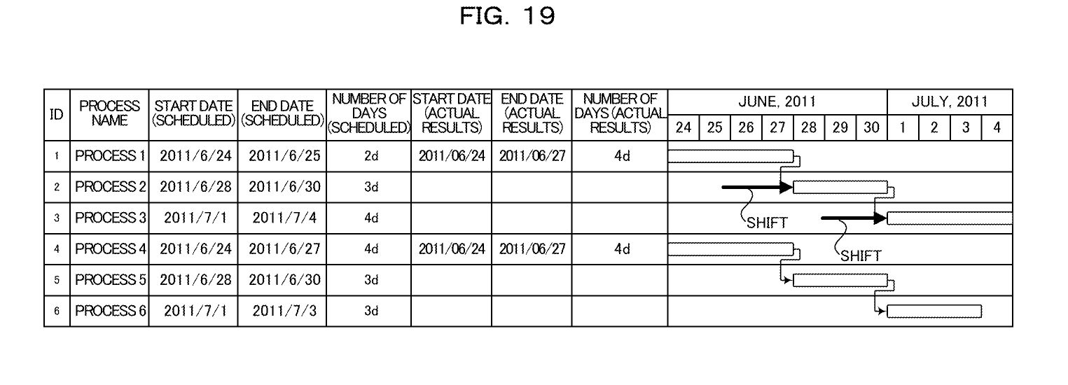

Then, if no difference is decided (for example, in the case of the process 4 of FIG. 18; NO route at step S150), then the processor 30 ends the processing. On the other hand, if some difference is decided (for example, in the case of the process 1 of FIG. 18; YES route at step S150), then the shift processor 39 shifts the start date (scheduled) and the end date (schedule) of a process, for which registration of actual results has not been carried out in a lower order of the process for which actual results have been registered in the schedule path to which the process for which actual results are registered belongs, by an amount equal to the difference (step S160). The shift processor 39 registers, as depicted in FIG. 19, the information after the shift (start date (scheduled) and end date (scheduled) of the process for which registration of actual results has not been carried out) into the process management list of the storage unit 20 (step S170).

In the example depicted in FIG. 18, since a delay of two days occur with the process 1, the shift processor 39 shifts the start date (scheduled) and the end date (scheduled) of the processes 2 and 3, for which registration of actual results has not been carried out in a lower order of the process 1 in the schedule path to which the process 1 belongs, so as to delay by two days. In particular, the start date (scheduled) 2011/6/26 and the end date (scheduled) 2011/6/28 of the process 2 are shifted to the start date (scheduled) 2011/6/28 and the end date (scheduled) 2011/6/30, respectively, as depicted in FIG. 19. Further, the start date (scheduled) 2011/6/29 and the end date (scheduled) 2011/7/2 of the process 3 are shifted to the start date (scheduled) 2011/7/1 and the end date (scheduled) 2011/7/4, respectively, as depicted in FIG. 19. It is to be noted that, as regards the process 4, the difference is zero, and no delay or no forwarding of the process occurs. Therefore, no process is carried out by the shift processor 39 (NO route at step S150).

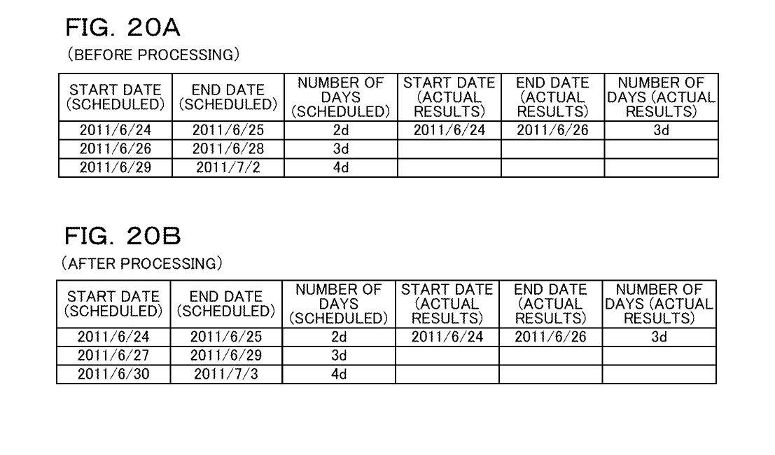

It is to be noted that, where both of a start date (actual results) and an end date (actual results) are registered for a certain process as depicted in FIG. 20A, a difference between the end date (actual results) and an end date (scheduled) corresponding to the end date (actual results) is calculated. Then, if delaying by one day is found as depicted in FIG. 20B, then the start date (scheduled) and the end date (scheduled) of another process following the process are shifted so as to delay each by one day.

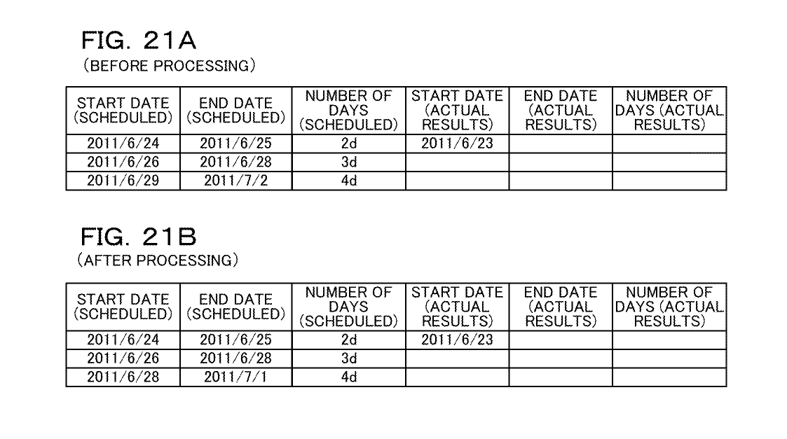

Further it is to be noted that, where a start date (actual results) is registered for a certain process as depicted in FIG. 21A, a difference between the start date (actual results) and a start date (scheduled) corresponding to the start date (actual results) is calculated. Then, if forwarding by one day is found as depicted in FIG. 21B, then the end date (scheduled) of the process is shifted forwardly by one day, and the start date (scheduled) and the end date (scheduled) of another process following the process are shifted forwardly each by one day.

Thereafter, for the processes following the process for which registration of actual results has been carried out, the second extraction unit 33 cooperates with the first decision unit 31 and the first extraction unit 32 to execute a process for detecting a schedule path and a simplified critical path (processes at steps S20 to S100 of FIG. 6) again (step S180).

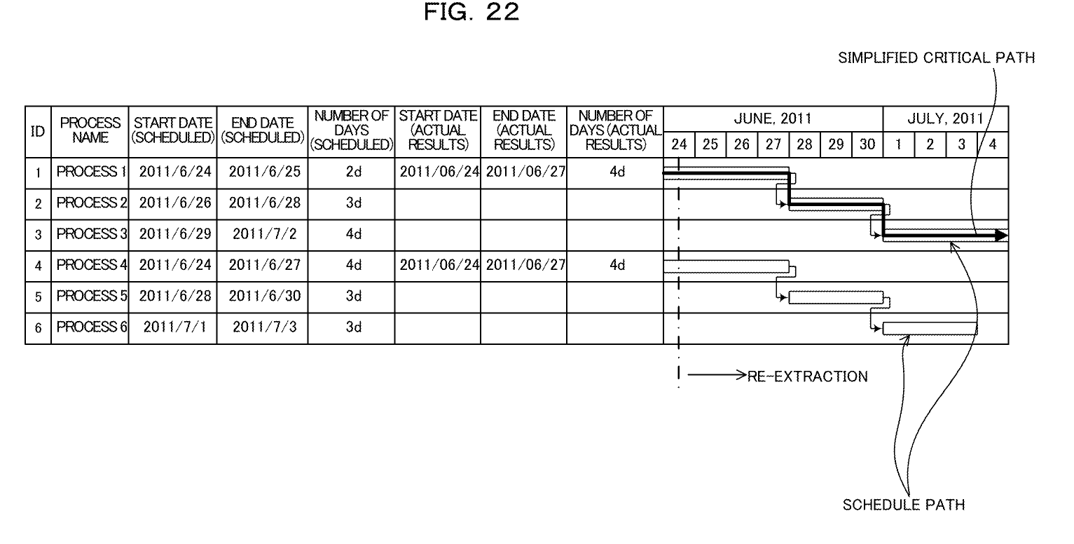

In the example depicted in FIG. 19, for the processes 2 and 3 for which registration of actual results has not been carried out as yet after the shift processing (after path adjustment) in the schedule path to which the process 1 for which registration of actual results has been carried out belongs and for the processes 5 and 6 for which registration of actual results has not been carried out in the other schedule path, the process of extracting a schedule path and a simplified critical path is executed again. Consequently, for example, as depicted in FIG. 22, two schedule paths, namely, a path including the processes 2 and 3 connected to each other by a dependency line and another path including the processes 5 and 6 connected to each other by a dependency line, are displayed. Further, of the two schedule paths, the path including the processes 2 and 3 connected to each other by a dependency line is displayed as a simplified critical path. In this manner, in the example depicted in FIGS. 17 to 19 and 22, although a path including the processes 4, 5 and 6 connected to each other by a dependency line is initially displayed as a simplified critical path, by reflecting actual results of the process 1, the path of the processes 2→3 is displayed as a simplified critical path.

[2-3] Working Effects of the Schedule Management Apparatus of the Second Embodiment

According to the schedule management apparatus 1A of the second embodiment, working effects similar to those achieved by the schedule management apparatus 1 of the first embodiment are achieved. Further, the start timing/end timing of a process are shifted and updated in response to a delay period/forwarding period of actual results obtained by executing the process. Consequently, changes to the schedule can be made readily. Further, since re-extraction and re-display of a schedule path and a simplified critical path are carried out automatically in accordance with the schedule (process management list) after the shift, the operator or the like can carry out review of the schedule readily and with certainty.

### (3) Others

Although the preferred embodiments of the present invention are described in detail above, the present invention is not limited to the particular embodiments but can be carried out in various modified or altered forms.

All or some of the functions as the first decision unit 31, first extraction unit 32, second extraction unit 33, second decision unit 34, third extraction unit 35, fourth extraction unit 36, display controller 37, difference calculation unit 38 and shift processor 39 described above are implemented by a computer (including CPUs, processors, information processing apparatus and various terminals) executing a predetermined application program (schedule management program).

The program is provided in a form in which it is recorded on a computer-readable recording medium such as a CD (CR-ROM, CD-R, CD-RW or the like), a DVD (DVD-ROM, DVD-RAM, DVD−R, DVD−RW, DVD+R, DVD+RW or the like), a Blu-ray disk or the like. In this instance, the computer reads out the program from the recording medium and transfers and stores to and into an internal storage apparatus or an external storage apparatus for later use.

Here, the term computer is used with a concept including hardware and an OS (Operating System) and signifies the hardware which operates under the control of the OS. In such a case that no OS is required and an application program itself operates the hardware, the hardware itself corresponds to the computer. The hardware includes at least a microprocessor such as a CPU, and means for reading a computer program recorded on a recording medium. The schedule management program described above includes program codes for making such a computer as described above implement the functions as the first decision unit 31, first extraction unit 32, second extraction unit 33, second decision unit 34, third extraction unit 35, fourth extraction unit 36, display controller 37, difference calculation unit 38 and shift processor 39. Further, some of the functions may be implemented not by the application program but by an OS.

All examples and conditional language recited herein are intended for pedagogical purposes to aid the reader in understanding the invention and the concepts contributed by the inventor for furthering the art, and are to be construed as being without limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A computer-readable recording medium storing a schedule management program that makes a computer manage a schedule of a work including a plurality of processes, the program instructing the computer to execute:
deciding, based on a scheduled start timing and a scheduled end timing registered in advance for each of the processes, whether or not the processes have a dependency relationship therebetween; and
extracting a plurality of schedule paths by connecting those of the processes decided to have the dependency relationship therebetween to each other.

2. The computer-readable recording medium according to claim 1, wherein the program instructs the computer to execute:
deciding that, from among the processes, a first process to be decided and a second process whose scheduled start timing is later than the scheduled end timing of the first process have the dependency relationship therebetween.

3. The computer-readable recording medium according to claim 1, wherein the program instructs the computer to execute:
extracting, from among the extracted schedule paths, a schedule path having a complicated process configuration as a simplified critical path.

4. The computer-readable recording medium according to claim 3, wherein the program instructs the computer to execute:
extracting a schedule path having the greatest number of stages of connected processes as the simplified critical path.

5. The computer-readable recording medium according to claim 4, wherein the program instructs the computer to execute:
extracting, where a plurality of schedule paths having the greatest number of stages of connected processes are extracted, a schedule path having the longest period as the simplified critical path from among the schedule paths having the equal number of stages.

6. The computer-readable recording medium according to claim 3, wherein the program instructs the computer to execute:
extracting, where the processes are grouped in a plurality of summaries, the simplified critical path for two or more processes included in each summary;
deciding, based on the scheduled start timings and the scheduled end timings registered in advance for the two or more processes included in each of the summaries, whether or not the summaries have a dependency relationship therebetween;
extracting a plurality of inter-summary paths by connecting those of the summaries decided to have the dependency relationship therebetween to each other; and
extracting, from among the extracted inter-summary paths, an inter-summary path having a complicated summary configuration as a simplified critical inter-summary path.

7. The computer-readable recording medium according to claim 6, wherein the program instructs the computer to execute:
extracting an inter-summary path having the greatest number of stages of connected summaries as the simplified critical inter-summary path; and
extracting, where a plurality of inter-summary paths having the greatest number of stages of connected summaries are extracted, an inter-summary path having the longest period as the simplified critical inter-summary path from among the inter-summary paths having the equal number of stages.

8. The computer-readable recording medium according to claim 1, wherein the program instructs the computer to execute:
calculating, where an actual start timing or an actual end timing is registered for a process started or ended in accordance with the progress of the work including the processes, a difference between the actual start timing and the scheduled start timing corresponding to the actual start timing or a difference between the actual end timing and the scheduled end timing corresponding to the actual end timing, regarding the schedule path to which the started or ended process belongs; and
shifting the scheduled start timing and the scheduled end timing of one or more processes later than the started or ended process by an amount corresponding to the calculated difference, regarding the schedule path to which the started or ended process belongs.

9. The computer-readable recording medium according to claim 8, wherein the program instructs the computer to execute:
extracting, after the scheduled start timing and the scheduled end timing are shifted by an amount equal to the difference, a simplified critical path again, regarding the one or more processes later than the started or ended process.

10. A schedule management apparatus that manages a schedule of a work including a plurality of processes, the schedule management apparatus comprising:
a storage unit into which a scheduled start timing and a scheduled end timing for each of the processes is registered in advance; and
a processor; wherein
the processor:
decides, based on the scheduled start timings and the scheduled end timings registered in the storage unit, whether or not the processes have a dependency relationship therebetween; and
extracts a plurality of schedule paths by connecting those of the processes decided to have the dependency relationship therebetween to each other.

11. The schedule management apparatus according to claim 10, wherein the processor decides, from among the processes, a first process to be decided and a second process whose scheduled start timing is later than the scheduled end timing of the first process have the dependency relationship therebetween.

12. The schedule management apparatus according to claim 11, wherein the processor extracts, from among the extracted schedule paths, a schedule path having a complicated process configuration as a simplified critical path.

13. The schedule management apparatus according to claim 12, wherein the processor extracts a schedule path having the greatest number of stages of connected processes as the simplified critical path.

14. The schedule management apparatus according to claim 13, wherein the processor extracts, where a plurality of schedule paths having the greatest number of stages of connected processes are extracted, a schedule path having the longest period as the simplified critical path from among the schedule paths having the equal number of stages.

15. The schedule management apparatus according to claim 12, wherein the processor:
extracts, where the processes are grouped in a plurality of summaries, the simplified critical path for two or more processes included in each summary;
decides, based on the scheduled start timings and the scheduled end timings registered in the storage unit for the two or more processes included in each of the summaries, whether or not the summaries have a dependency relationship therebetween;
extracts a plurality of inter-summary paths by connecting those of the summaries decided to have the dependency relationship therebetween to each other; and
extracts, from among the extracted inter-summary paths, an inter-summary path having a complicated summary configuration as a simplified critical inter-summary path.

16. The schedule management apparatus according to claim 15, wherein the processor:
extracts an inter-summary path having the greatest number of stages of connected summaries as the simplified critical inter-summary path; and
extracts, where a plurality of inter-summary paths having the greatest number of stages of connected summaries are extracted, an inter-summary path having the longest period as the simplified critical inter-summary path from among the inter-summary paths having the equal number of stages.

17. The schedule management apparatus according to claim 10, wherein the processor:
calculates, where an actual start timing or an actual end timing is registered for a process started or ended in accordance with the progress of the work including the processes, a difference between the actual start timing and the scheduled start timing corresponding to the actual start timing or a difference between the actual end timing and the scheduled end timing corresponding to the actual end timing, regarding the schedule path to which the started or ended process belongs; and
shifts the scheduled start timing and the scheduled end timing of one or more processes later than the started or ended process by an amount corresponding to the calculated difference, regarding the schedule path to which the started or ended process belongs.

18. The schedule management apparatus according to claim 17, wherein the processor extracts, after the scheduled start timing and the scheduled end timing are shifted by an amount equal to the difference, a simplified critical path again, regarding the one or more processes later than the started or ended process.

19. A schedule management method for managing a schedule of a work including a plurality of processes, the schedule management method comprising:
registering a scheduled start timing and a scheduled end timing for each of the processes into a storage unit in advance;
deciding, based on the scheduled start timings and the scheduled end timings registered in the storage unit, whether or not the processes have a dependency relationship therebetween; and
extracting a plurality of schedule paths by connecting those of the processes decided to have the dependency relationship therebetween to each other.

20. The schedule management method according to claim 19, wherein, where an actual start timing or an actual end timing is registered for a process started or ended in accordance with the progress of the work including the processes, a difference between the actual start timing and the scheduled start timing corresponding to the actual start timing or a difference between the actual end timing and the scheduled end timing corresponding to the actual end timing, regarding the schedule path to which the started or ended process belongs is calculated; and
the scheduled start timing and the scheduled end timing of one or more processes later than the started or ended process are shifted by an amount corresponding to the calculated difference, regarding the schedule path to which the started or ended process belongs.
